(19) United States
(12) Patent Application Publication
(10) Pub. No.: US 2008/0195978 A1
(43) Pub. Date: Aug. 14, 2008

(54) METHOD AND APPARATUS FOR COMMUNICATING NAVIGATION INFORMATION

(75) Inventors: David S. Wissenbach, Tempe, AZ (US); Steven E. Hales, Phoenix, AZ (US); Choy Wai Lee, Olathe, KS (US); Robert C. Pappas, Lenexa, KS (US); Paul J. Cooper, Overland Park, KS (US); Aaron E. Roller, Sausalito, CA (US); Bradley K. Culberson, Boulder, CO (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 11/673,925

(22) Filed: Feb. 12, 2007

(51) Int. Cl. G06F 3/048

(52) U.S. Cl. 715/854

(57) ABSTRACT

A computer program operable to interface with a browser and access a navigation device to utilize navigation information. The computer program may acquire information from the navigation device and provide the acquired information to the browser. The computer program may also acquire navigation information from the browser and provide the acquired information to the navigation device.

### BACKGROUND

1. Field

Embodiments of the present invention relate to apparatus and methods for communicating navigation information. More particularly, the present invention is directed to apparatus and methods, which may be implemented as a computer program, for interfacing with a browser and accessing a navigation device to utilize navigation information.

2. Description of the Related Art

Navigation devices are commonly employed to generate information for fitness, entertainment, and navigation purposes. Navigation devices may be configured to calculate travel routes and provide guidance using the Global Positioning System (GPS). Navigation devices are often configured to store navigation information, such as points of interest, travel routes, exercise and position information, combinations thereof, and the like.

To utilize stored navigation information with remote computing devices, users are typically required to install and run stand-alone personal computer (PC) applications or access a dedicated application server. Consequently, it is often difficult for users to access web pages that incorporate data generated by navigation devices. Accordingly, it would be advantageous to provide an improved method for interfacing with a browser and accessing a navigation device to utilized navigation information.

### SUMMARY

The present invention is directed to apparatus and methods, capable of being implemented as a computer program, for interfacing with a browser and accessing a navigation device to utilize navigation information. In one embodiment, an apparatus and method in accordance with the present invention may acquire information from the navigation device and provide the acquired information to the browser. In another embodiment, the apparatus and method may acquire navigation information from the browser and provide the acquired information to the navigation device. Thus, in various embodiments, the apparatus and methods of the present invention enable navigation information to be easily acquired and utilized with the browser when accessing web pages and other content.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWING FIGURES

Various embodiments of the present invention are described in detail below with reference to the attached drawing figures, wherein:

FIG. 1 is a block diagram illustrating a plurality of computing devices coupled through a communications network;

FIG. 2 is schematic diagram of a Global Positioning System (GPS);

FIG. 3 is a block diagram illustrating a browser plug-in configured in accordance with various embodiments of the present invention;

FIG. 4 is a block diagram illustrating various functionality of the plug-in of FIG. 3;

FIG. 5 is an exemplary screen shot of a web page including an exemplary input provided by the plug-in of FIGS. 3 and 4;

FIG. 6 is a block diagram showing an exemplary conversion of a street address to a geocode for storing on various devices;

FIG. 7 is a block diagram illustrating some of the functions operable to be performed by various embodiments of the present invention; and

FIG. 8 is a block diagram illustrating some of the functions operable to be performed by various embodiments of the present invention in more detail.

The drawing figures do not limit the present invention to the specific embodiments disclosed and described herein. The drawings are not necessarily to scale, emphasis instead being placed upon clearly illustrating various embodiments of the invention.

### DETAILED DESCRIPTION

The following detailed description of various embodiments of the invention references the accompanying drawings which illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

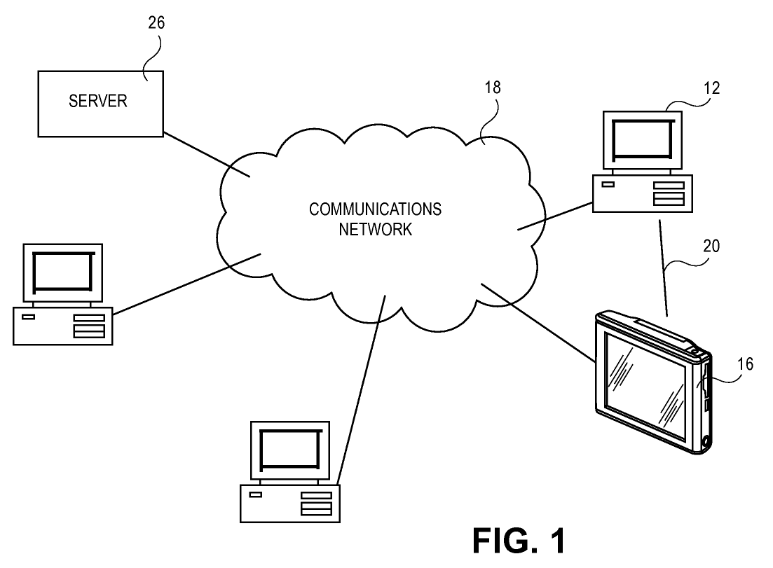

In various embodiments, the present invention may be implemented utilizing a computer program 10 operable to operate and/or enable functionality in one or more computing devices such as the computing device 12 illustrated in FIGS. 1 through 8. In some embodiments, the computer program 10 is operable to interface with a browser 22 utilized by the computing device 12 to enable the browser 22, computing device 12, and other programs and devices to utilize navigation information stored on a navigation device 16.

In specific embodiments, the computer program 10 may be configured as, or to include, a browser plug-in. However, the principles of various embodiments of the present invention are useful independent of any particular implementation, and some embodiments may be implemented without the assistance of the computer program 10 and computing device 12.

The computing device 12 may comprise various computing elements such as personal computers, portable computing devices such as laptops and personal digital assistants, servers, processors, controllers, media devices and media centers, consumer electronic devices, personal navigation devices, computing networks and distributed computing networks, combinations thereof, and the like. Thus, the computing device 12 may comprise a plurality of computing elements in some embodiments. The computing device 12 may include memories of any form or configuration for storing computer programs and information, as is discussed in more detail below.

As shown in FIG. 1, the computing device 12 may be operable to access a communications network 18 such as an intranet, peer-to-peer network, and/or the internet to exchange information with other computing devices associated with and/or connected to the communications network 18. The computing device 12 may be operable to access the communications network 18 utilizing wired and/or wireless connections.

In various embodiments, the computing device 12 includes the browser 22 that enables a user of the computing device 12 to navigate various objects, such as documents, files, text, web pages, and the like, through a connecting structure. In some embodiments, the browser 22 is a web browser operable to interface with the communications network 18 to display web pages. Thus, the browser 22 may include any web browser operable to access and display web pages in a generally conventional manner, including but not limited to, the Internet Explorer, Mozilla Firefox, Safari, Netscape, and Opera browsers. The browser 22 may be operable to interface with other computer programs, such as the computer program 10 discussed herein, to provide additional functionality to users. In some embodiments, the browser may be configured to utilize one or more plug-ins as is discussed in more detail below.

The computer program 10 may comprise instructions for implementing functions in one or more computing devices such that the program 10 is not limited to functioning and/or controlling only the computing device 12. The program 10 may also comprise various code segments, which each may include one or more instructions, one or more instruction lists, only a portion of an instruction list, and/or only a portion of an instruction. Code segments may include overlapping lists of instructions, that is, a first code segment may include at least portions of instructions A and B, and a second code segment may include at least portions of instructions B and C. Each code segment may be embodied as human-readable source code or script, as machine-readable object code, and/or as one or more machine-executable files such as compiled source code. Further, the computer program 10 may comprise one or more computer programs each including any number of code segments to perform any of the functions disclosed herein.

The computer program 10 may be stored in or on at least one computer-readable medium accessible by one or more computing devices, such as the computing device 12, to enable one or more computing devices to implement the various functions of the computer program 10. In the context of this application, a “computer-readable medium” can be any element or combination of elements that can contain, store, communicate, propagate or transport at least a portion of the program 10 for use by or in connection with one or more computing devices such as the computing device 12.

The computer-readable medium can be, for example, but not limited to, an electronic, magnetic, optical, electromagnetic, infrared, or semi-conductor system, apparatus, device, or propagation medium operable for use by the computing device 12 or other devices. More specific, although not inclusive, examples of the computer-readable medium may include the following: an electrical connection having one or more wires, a portable computer diskette, a random access memory (RAM), a read-only memory (ROM), an erasable, programmable, read-only memory (EPROM or flash memory), an optical fiber, a portable compact disc (CD), a digital video disc (DVD), and an electrical signal representing one or more portions of the computer program 10. The computer-readable medium could even be paper or another suitable medium upon which the program 10 is printed, as the program 10 can be electronically captured, via for instance, optical scanning of the paper or other medium, then compiled, interpreted, or otherwise processed in a suitable manner, if necessary, and then stored in a computer memory.

However, embodiments of the present invention may be implemented in hardware, software, firmware, and/or combinations thereof and are not limited to the computer program 10 discussed herein. The computer program 10 and associated equipment are merely examples of a program and equipment that may be used to implement embodiments of the present invention and may be replaced with other software and/or equipment without departing from the scope of the present teachings.

The navigation device 16 may be integral with the computing device 12, such that the program 10 may be executed at least partially by the navigation device 16. However, in other embodiments, the navigation device 16 is discrete from the computing device 12 and is operable to be locally accessed by the computing device 12 to enable the exchange of information. The computing device 12 may locally access the navigation device 16 through one or more connections 20 such as cables, short-range wireless connections, combinations thereof, and the like. For example, each connection 20 may include a universal serial bus (USB) cable, a Firewire cable, a Bluetooth connection, a ZigBee connection, a Wi-Fi (802.11) network or connection, combinations thereof, and the like.

The navigation device 16 may be any electronic device or system operable to receive, utilize, or otherwise determine geographic information, such as a current geographic location. Thus, the navigation device 16 may include computers, televisions, radios, portable computing devices such as laptops or personal data assistants (PDAs), personal travel assistants, cellular telephones, portable entertainment devices, and the like. In specific embodiments, the navigation device 16 may comprise a personal navigation device manufactured and sold by GARMIN INTERNATIONAL, INC. of Olathe, Kans.

In various embodiments, the navigation device 16 includes a Global Positioning System (GPS) receiver adapted to provide, in a substantially conventional manner, geographic location information for the navigation device 16. For example, the navigation device 16 may include a GPS receiver much like those disclosed in U.S. Pat. No. 6,434,485, which is incorporated herein by specific reference. However, the navigation device 16 may use cellular or other positioning signals instead of, or in addition to, the GPS to facilitate determination of geographic locations.

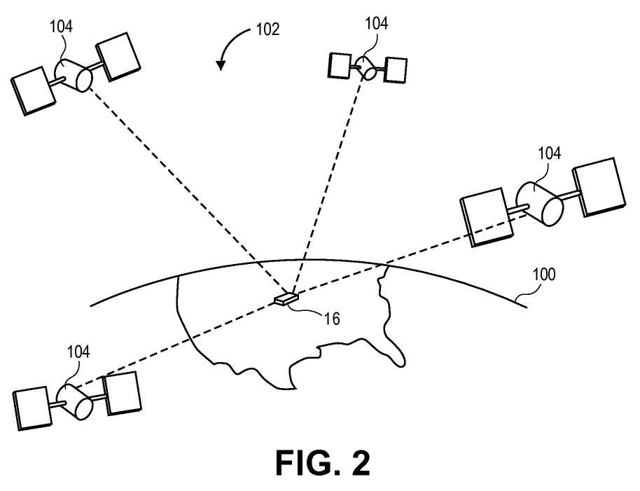

The GPS is a satellite-based radio navigation system that allows determination of navigation information, such as position, velocity, time, and direction, for an unlimited number of users. Formally known as NAVSTAR (Navigation Signal Timing and Ranging), the GPS incorporates a plurality of satellites that orbit the earth. FIG. 2 shows one representative view of a GPS denoted generally by reference numeral 102. A plurality of satellites 104 are in orbit about the Earth 100. The orbit of each satellite is not necessarily synchronous with the orbits of other satellites and, in fact, is likely asynchronous. The navigation device 16 is shown receiving spread spectrum GPS satellite signals from the various satellites 104.

In various embodiments, the navigation device 16 is operable to generate navigation information utilizing the GPS receiver and/or other sensing elements. The navigation information may include a current geographic location of the navigation device 16; previous geographic locations of the navigation device 16; routes between geographic locations; travel history information such as average speed, distance traveled, gas mileage, traffic conditions, and the like; fitness information such as distance traveled, calories burned, speed, route, heart rate, power, elevation, aggregate performance information such as laps, and the like; and configuration information for the navigation device 16 such as software and firmware versions, model number, and the like.

However, the navigation information may include any information operable to be retained and/or generated by navigation devices. The navigation information may be stored within at least one computer-readable memory associated with the navigation device 16 to enable the computing device 12 to access the navigation information through the connection 20, as is discussed in more detail below.

The navigation information retained and/or generated by the navigation device 16 may be embodied in human-readable text form and/or machine-readable binary form. In some embodiments, the navigation device 16 is operable to store data in the GPS Exchange (GPX) format. The GPX format allows navigation data, such as waypoints, tracks, points of interests, routes, and the like, to be stored utilizing the Extensible Markup Language (XML). The navigation device 16 may also store data in a training center data (TCX) format (e.g., using files with file name extensions such as, for example, .WKT, .HST, CRS, or the like) that retains fitness information utilizing XML.

The navigation device 16 may also retain binary GPI, RGN, and IMG files to represent maps, points of interests, and associated voice information and data. Further, the navigation device 16 may retain an unlock file (UNL) that includes one or more unlock codes to verify that a user is licensed to use a particular service or data set.

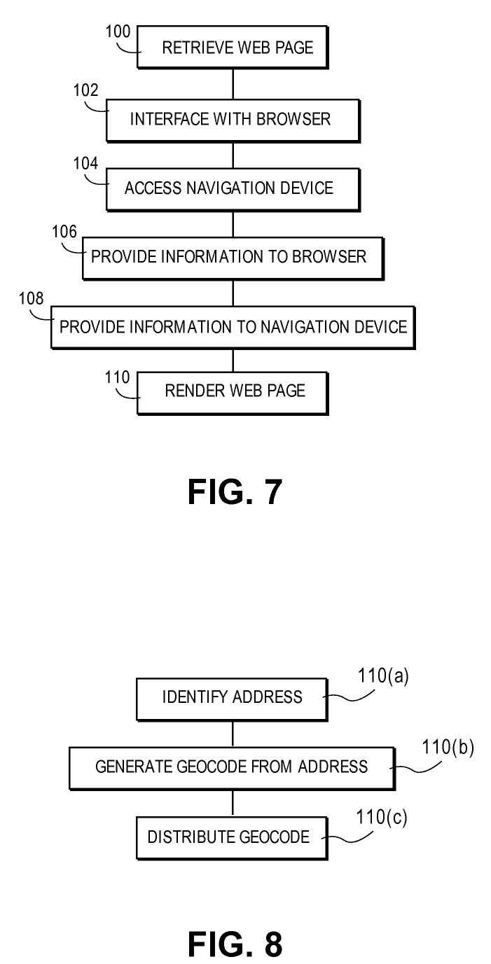

A flowchart of some of the functions that may be performed by embodiments of the present invention is illustrated in FIG. 7 as steps 100 through 110. Some of the blocks of the flow chart may represent one or more code segments comprising at least a portion of the computer program 10. Steps 100-110 may be performed in any order and are not limited to the specific order described herein. Further, steps 100-110 may be performed simultaneously or concurrently such that the steps are not necessarily sequential. Further, steps 100-110 are not each necessarily performed by all embodiments of the present invention.

In step 100, a web page 24 is retrieved from a server 26. In various embodiments, the computing device 12 retrieves the web page 24 from the server 26 through the communications network 18 in a substantially conventional manner. For example, a user may use the browser 22 to navigate to a particular internet address and/or uniform resource locator (URL) whereupon the browser 22 may request that the server 26 serve the web page 24, or other content, associated with the address or URL. However, the web page 24 may be retrieved utilizing any methods as embodiments of the present invention are not limited to accessing web pages through the communications network 18. For example, the web page 24 may be stored in a computer-readable medium local to the computing device 12 or navigation device 16 such that use of the server 26 and communications network 18 are not required.

In various embodiments, the web page 24 is configured to utilize navigation information generated and/or stored on the navigation device 16. As is discussed in more detail below, the web page 24 may process, format, and display in any manner the various navigation information stored or generated by the navigation device 16. The web page 24 may include markup language commands to display information and content in a desired manner, such as by utilizing the hypertext markup language (HTML) and/or the extensible hypertext markup language (XHTML). In some embodiments, the web page 24 may include or otherwise be associated with a script 28 operable to be executed by the browser 22 or other software running on the computing device 12 to provide additional functionality. This script may further augment the web page 24 by transferring content such as extensible markup language (XML) using web services.

In some embodiments, the script 28 is operable to be executed by the browser 22 to utilize the computer program 10, as is discussed in more detail below. For example, the script 28 may include commands requesting that various navigation information be transferred to, retrieved from, and/or accessed on the navigation device 16 for display by the computing device 12 in a format defined by the web page 24. Thus, upon retrieving the web page 24 in step 100, the computer program 10 may be instructed by the script 28 and/or browser 22 to perform any of the other functions defined by steps 102-108.

The script 28 may include various commands and instructions operable to be utilized by the computing device 12 and/or browser 22 to perform various functions. In some embodiments, the script 28 is embodied in JavaScript (client-side JavaScript) or VBScript to enable execution by conventional browsers and computing devices. However, the script 28 may be embodied in any format operable to be executed by the computing device 12 and/or browser 22 and is not limited to the particular formats identified above. Further, the script 28 may comprise a plurality of scripts embodied in any language operable to cause the computing device 12 to perform any function.

In step 102, the computer program 10 is interfaced with the browser 22 or other software executed by the computing device 12. The program 10 and browser 22 may be interfaced in any manner that allows data to be provided to the browser 22 from the program 10 and/or that allows data to be provided to the program 10 from the browser 22. In various embodiments, at least a portion of the computer program 10 is configured as a browser plug-in to facilitate the integration of the computer program 10 within the browser 22. However, the program 10 and browser 22 need not be directly interfaced as data may be exchanged utilizing intermediate programs or applications.

Step 102 may be performed at any time and is not necessarily performed after step 100. For example, the program 10 may be interfaced with the browser 22 when the program 10 is installed by the user. Thus, the user may provide a computer-readable medium to the computing device 12, and/or download the program 10 through the communications network 18, to interface the program 10 with the browser 22. Further, in some embodiments, the program 10 may be an integral part of the browser 22, such as by forming a permanent part of the browser 22, such that it is not necessary to separately integrate the program 10 and browser 22.

Step 102 may also be performed in response to retrieval of the web page 24 in step 100. For example, the web page 24 may include an object tag or other identifier to indicate that the program 10 should be used to view the web page 24. In response to the object tag and/or other identifier, the browser 22 may detect if it has been interfaced with the program 10, and if not, be directed to an internet address or URL to retrieve and interface with the program 10. Thus, the program 10 and browser 22 may be interfaced after the web page 24 has been accessed even if the user is unaware that the web page 24 requires use of the program 10.

In step 104, the program 10 accesses the navigation device 16 utilizing the computing device 12. In particular, the program 10 may instruct the computing device 12 to access the navigation device 16 through the connection 20. Step 104 may be performed in response to, or in combination with, steps 100 and 102, such as where the script 28 instructs the browser 22 to detect if the navigation device 16 is coupled with the computing device 12 and/or where the navigation device 16 is accessed after or while the program 10 is interfaced with the browser 22 to facilitate the performance of steps 106 and 108.

The program 10 may access the navigation device 16 to determine the status of the navigation device 16 and/or the status of the connection 20. The program 10 may also access the navigation device 16 to acquire the navigation information generated or stored therein and/or provide information to the navigation device 16, as is discussed in more detail below. The information acquired by the program 10 in step 104 may be dictated by the web page 24 and specifically the script 28. For example, the script 28 may include an instruction requesting the display or retrieval of a particular type of navigation data, such as previous locations of the navigation device 16. The browser 22 may execute the instruction to cause the program 10 to retrieve the indicated data.

The program 10 may also access the navigation device 16 to determine the amount, status, and/or type of the navigation information stored or generated by the navigation device 16. The accessed and acquired navigation information may be temporarily or permanently stored on the computing device 12 for later access by the browser 22, as is discussed in more detail below.

In some embodiments, a plurality of navigation devices may be coupled with the computing device 12. In such embodiments, the program 10 may be operable to poll the various devices coupled with the computing device 12 and determine which devices are compatible with the web page 24 based on information provided by the web page 24 and/or script 28. If more than one compatible device exists, the program 10 and/or browser 22 may prompt the user to select which one of the devices to access. However, in some embodiments the program 10 may access a plurality of navigation devices and exchange information with the plurality of navigation devices.

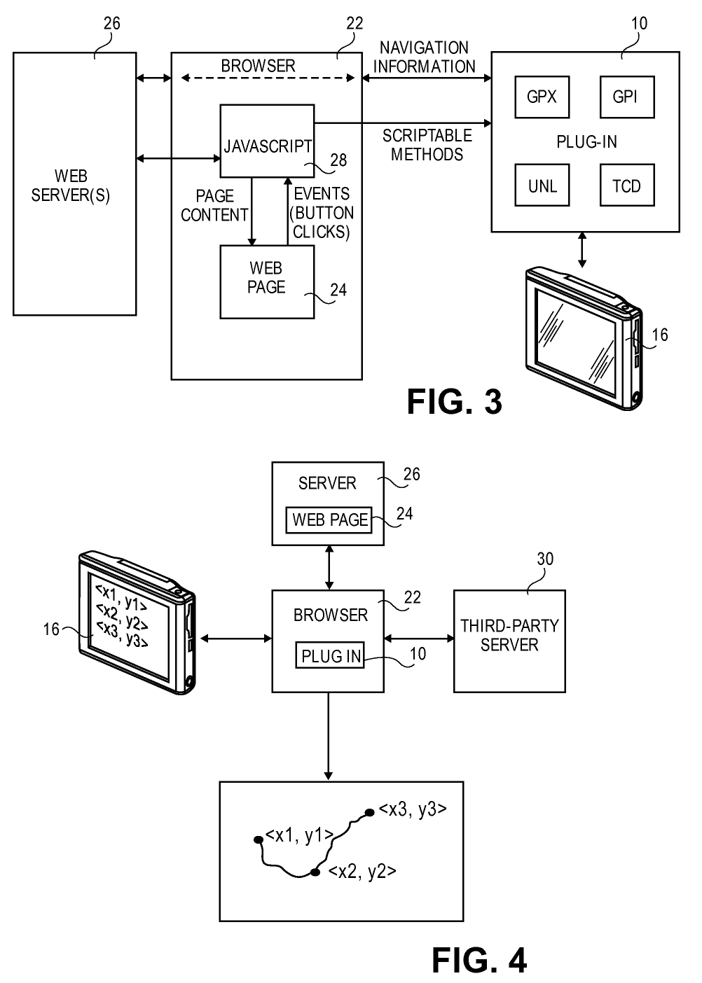

In step 106, the program 10 may provide information to the browser 22. The program 10 may provide the navigation information accessed in step 104 to the browser 22 for use in displaying the web page 24. For example, as shown in FIG. 3, the web page 24 and/or script 28 may indicate that a particular type of navigation data, such as GPX data, is to be utilized. The browser 22 and/or program 10 may identify the particular type of requested data and the program 10 may retrieve the requested data for use by the browser 22. The program 10 may provide information to the browser 22 by enabling the browser 22 to access the information, by storing the data in a memory address accessible or utilized by the browser 22, combinations thereof, and the like.

The program 10 may format and/or process information acquired from the navigation device 16 before or after providing the acquired information to the browser 22. For example, the program 10 may convert data stored and/or generated by the navigation device 16 into an appropriate format for use by the computing device 12 or for display by the browser 22 as dictated by the web page 24. The program 10 may also organize, sort, or categorize information before providing it to the browser 22 according to user preferences provided by the user of the computing device 12 and/or according to pre-defined criteria defined by the navigation device 16, computing device 12, web page 24, and/or other devices and elements.

Additionally or alternatively, the program 10 may provide navigation information acquired from the navigation device 16 to computing devices other than the computing device 12. For example, in some embodiments the program 10 and/or browser 22 may provide acquired navigation information to the server 26 or other computing devices connected to the communications network 18, such as a third-party server 30, as is shown in FIG. 4. The web page 24 and/or script 28 may dictate to what devices the navigation information is provided. For example, the web page 24 and/or script 28 may request that the program 10 provide navigation information acquired from the navigation device 16 to the server 26 hosting the web page 24 or any other computing devices.

Step 106 may be performed in combination with other steps, such as steps 100-104, and is not necessarily performed in the order illustrated in FIG. 7. For example, the program 10 may interface with the browser 22 and access the navigation device 16 to retrieve information there from before accessing the web page 24. The program 10 may also access the navigation device 16 to retrieve information there from in response to requests made by the web page 24, script 28, and/or browser 22, as is discussed above. Further, step 106 is not necessarily performed in all embodiments as the program 10 may be configured to only provide information from the browser 22 to the navigation device 16.

In step 108, the program 10 may provide information to the navigation device 16 for storage and/or use by the navigation device 16. For example, the computing device 12 may access and/or otherwise acquire various information from other computing devices connected to the communications network 18 utilizing the browser 22 or other computer programs. The program 10 may then be operable to provide the acquired information, or any other information stored or otherwise accessible by the computing device 12, to the navigation device 16 utilizing the connection 20.

In some embodiments, the program 10 may format and/or process information accessed by the computing device 12 and then may provide the formatted and/or processed information to the navigation device 16. For example, the program 10 may convert data accessed by the computing device 12 through the communications network 18 into an appropriate format for use by the navigation device 16. The program 10 may also organize, sort, or categorize information before providing it to the navigation device 16 according to user preferences provided by the user of the computing device 12 and/or according to pre-defined criteria defined by the navigation device 16, computing device 12, web page 24, and/or other devices and elements.

Step 108 may be performed in combination with other steps, such as steps 100 through 106, and is not necessarily performed in the order illustrated in FIG. 7. For example, the program 10 may interface with the browser 22 and access the navigation device 16 to provide information thereto before accessing the web page 24. The program 10 may also access the navigation device 16 to provide information thereto in response to requests made by the web page 24, script 28, and/or browser 22, as is discussed above. Further, step 108 is not necessarily performed in all embodiments as the program 10 may be configured to only acquire information from the navigation device 16.

In step 110, the browser 22 may display or otherwise render the web page 24. For example, the browser 22 may control the computing device 12, and/or interface with an operating system of the computing device 12, to display information on the computing device 12 in accord with the HTML, XHTML, script 28, or other web page 24 instructions and content. Thus, the browser 22 may display at least portions of the web page 24 in a generally conventional manner.

The web page 24 displayed by the browser 22 may also utilize the navigation information acquired from the navigation device 16 in step 106. For example, at least a portion of the navigation information acquired from the navigation device 16 may be displayed by the browser 22 as defined by the web page 24 and/or script 28.

Further, the browser 22 may display the web page 24, and then in response to an input received by the user and/or as indicated by the script 28, provide information associated with the web page 24 to the navigation device 16 in step 108. For example, in some embodiments as illustrated in FIG. 8, step 110 may include: identifying an address, referenced at step 110(a); generating a geocode from the identified address, referenced at step 110(b); and distributing the geocode, referenced at step 110(c).

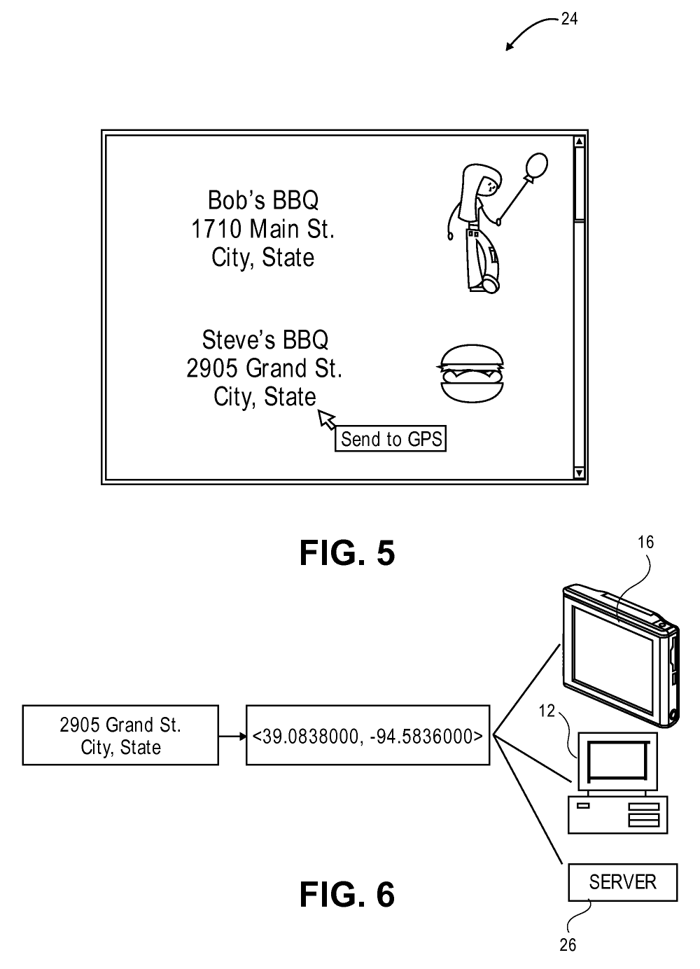

In step 110(a), an address may be identified. For example, as shown in FIG. 5, the browser 22 may display a web page 24 listing one or more addresses. The browser 22 and/or program 10 may be configured to automatically identify one or more addresses listed by the web page 24 for use in step 110(b). In some embodiments, the browser 22 and/or program 10 may automatically identify displayed addresses and present an icon or pop-up window by each address to enable the user to select which addresses should be distributed.

Additionally or alternatively, the program 10 and/or browser 22 may identify the address by enabling the user of the browser 22 to identify the address. For example, the user may right-click, or otherwise select, one or more displayed addresses to instruct the program 10 and/or browser 22 to send the address to the navigation device 16 or other devices for use.

The program 10 and/or browser 22 may also provide drag-and-drop functionality without requiring a user to right-click and select a menu option. For example, the program 10 and and/or browser 22 may allow the user to identify an address by highlighting the address and then dragging the highlighted address to a screen area, such as a GPS icon, an application icon, a window area, combinations thereof, and the like.

In step 110(b), the one or more addresses identified in step 110(a) are used by the program 10 and/or browser 22 to generate one or more geocodes. “Geocode” as utilized herein refers to a geographical code operable to identify a point or area at or on the surface of the Earth. The geocode or geocodes generated in step 110(b) may correspond to any type of geocode and are not limited to a particular format. In various embodiments, the geocode generated in step 110(b) corresponds to the geocode format employed by the navigation device 16.

In some embodiments, the generated geocodes may be embodied in a latitude and longitude format that corresponds to the latitude and longitude of a position on the Earth, as is shown in FIG. 8. Thus, in some embodiments, the geocodes may be in degree:minute, degree:minute:second, decimal degree format, and/or the Geographic Coordinate System (1983) format. The one or more generated geocodes may be stored by the computing device 12 within one or more computer-readable memories to facilitate distribution in step 110(c).

The geocodes may be generated from address databases, algorithms, look-up tables, or other applications and programs operable to convert, identify, locate, or otherwise define a geocode based on an address. In some embodiments, the computing device 12 may access devices connected to the communications network 18 to acquire the geocode and/or the computing device 12 may have information stored within its memory to enable the generation of a geocode from a given address.

The program 10 and/or browser 22 may also be configured to identify errors or problems with the generation of one or more geocodes. For example, in some situations, the address identified in step 110(a) may be incomplete or otherwise unsuitable for the generation of a geocode. Thus, in some embodiments, the program 10 and/or browser 22 may prompt the user for additional information to enable the generation of a geocode. The program 10 and/or browser 22 may also recommend addresses to the user that are similar to the address identified in step 110(a) to facilitate the generation of accurate geocodes.

In step 110(c), the one or more geocodes generated in step 110(b) are distributed by the program 10 and/or browser 22. In some embodiments, the geocodes may be distributed to the navigation device 16 through the connection 20. For example, the user may identify a restaurant's address in step 110(a), the program 10 and/or browser 22 may generate a geocode corresponding to the address in step 110(b), and in step 110(c) the program 10 and/or browser 22 may provide the geocode to the navigation device 16. Upon reception of the geocode, the navigation device 16 may calculate a route to the address, display a map of the area surrounding the address, add the address to its memory for later retrieval and access, add the address as a point of interest or waypoint, combinations thereof, and the like. Thus, by selecting an address displayed on the web page 24 the user may easily transfer the address to the navigation device 16 for navigation purposes without having to manually input the address into the navigation device 16.

The program 10 and/or browser 22 may additionally or alternatively distribute the generated geocodes to devices other than the navigation device 16. For example, as shown in FIG. 6, the geocodes may be stored on the computing device 12 for later use by the program 10 or other applications. The geocodes may also be distributed to other computing devices through the communications network 18, such as to the server 26 or the third-party server 30, to enable the user to access the geocodes from any location or device. However, as should be appreciated, the geocodes may be distributed in any manner to any device.

Steps 110(a) through 110(c) may be performed in any order, including simultaneously. Thus, in various embodiments the program 10 may automatically identify addresses presented by the web page 24, generate geocodes corresponding to the addresses, and distribute the geocodes to the navigation device 16 without requiring any input by the user. Further, steps 110(a) through 110(c) are not necessarily performed in all embodiments as the program 10 may provide other navigation information to, and receive other navigation information from, the navigation device 16.

In some embodiments as shown in FIG. 4, the browser 22 may present a map including at least some of the navigation information acquired from the navigation device 16 in step 106. For example, the navigation information acquired from the navigation device 16 may include previous locations of the navigation device 16, routes and trips calculated by the navigation device 16, points of interests, waypoints, fitness information and corresponding locations, device configuration information, combinations thereof, and the like. The browser 22 may generate the map utilizing information stored on the computing device 12 and/or by utilizing information stored on devices coupled with the communications network 18. For instance, the browser 22 may generate a map utilizing the Google Maps service and overlay or otherwise position the navigation data on the generated map. Thus, the program 10 and/or browser 22 may utilize the acquired navigation information in combination with other services and applications in presenting the web page 24.

In embodiments where the acquired navigation information includes fitness information, the browser 22 may present the web page 24 utilizing the fitness information. For example, the browser 22 may present the web page 24 to summarize the acquired fitness information, compare the acquired fitness information to previously-acquired fitness information, compare the acquired fitness information with fitness information provided by other users or devices, plot fitness information and associated locations on a map, provide analysis of the fitness information, combinations thereof, and the like.

In some embodiments, the user may update or upgrade the navigation device 16 by accessing the web page 24. For example, the navigation information acquired from the navigation device 16 in step 106 may include configuration information for the navigation device 16, such as the current version or model of the navigation device 16, its software, and/or associated data. The program 10 and/or browser 22 may compare the acquired configuration information to current configuration information provided by the web page 24 or other sources accessible through the communications network 18. The program 10 and/or browser 22 may then alert the user if the navigation device 16 needs to be upgraded or updated.

In some embodiments, the program 10 may access updated navigation information from the computing device 12 or other sources accessible through the communications network 18 and provide the navigation device 16 with the updated navigation information in step 106. Thus, the user may easily update or upgrade the navigation device 16 by using the browser 22 and navigating to the web page 24. Further, the program 10 and/or browser 22 may provide the unlock file associated with the navigation device 16 to remote sources to establish that the user and/or navigation device 16 is entitled to the updated navigation information or other content.

As the program 10 may interface with the browser 22 for execution by the computing device 12, without being executed by the server 26 of the web page 24, the navigation information provided to the browser 22 by the program 10 may be displayed, modified, altered, processed, formatted, combinations thereof, and the like, for use with the web page 24 before the information is provided to other devices such as the server 26 or the third-party server 30. Thus, for example, the program 10 may acquire navigation information from the navigation device 16 for display by the browser 22 and the user many view and modify the navigation information as needed without requiring interaction with the server 26 or third-party server 26. The user may then use the program 10 and/or browser 22 to transfer the acquired navigation information and/or modified navigation information to the server 26 or other devices such as the third-party server 30 or personal computers for sharing or comparison with other users. Consequently, the program 10 may enable users to view, modify, and process navigation information before distribution without the assistance of the server 26 or third-party server 30.

The navigation information provided by the program 10 and/or browser 22 to other devices, such as the server 26 or third-party server 30, may be in any format. Thus, for example, the program 10 and/or browser 22 may provide binary data to various devices through the communications network 18. However, in some embodiments, to facilitate the rapid and quick exchange of data between devices and web servers, the program 10 and/or browser 22 may be operable to post data in text format, such as XML-associated information, to various servers using conventional web form constructs. Thus, even if the computing device 12 is positioned behind a conventional firewall, the user may still provide navigation information to others by posting data through the browser 22 as the program 10 does not require the use of special protocols or connections for communication through the communications network 18.

Consequently, in various embodiments the program 10 enables the user of the navigation device 16 to access any web page to utilize navigation information acquired from, or provided to, the navigation device 16 in combination with the content of the web page. Further, the web page 24 and associated script 28 may be conventionally provided by web servers and computing devices such that special programs, scripts, and other server-side applications need not be executed to enable communication of the navigation information. For instance, anyone may create a web page and/or associated script for distribution through the communications network 18 for access by any conventional browser to enable use of the program 10 and navigation device 16. Thus, various embodiments of the present invention simplify the process of acquiring information from, and providing information to, navigation devices.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A computer program stored on at least one computer-readable medium for operating a computing device, comprising:
a code segment operable to locally access a navigation device to acquire navigation information;
a code segment operable to interface with a browser; and
a code segment operable to provide at least a portion of the acquired navigation information to the browser.

2. The computer program as claimed in claim 1, wherein at least one of the code segments includes a plug-in for the browser.

3. The computer program as claimed in claim 1, wherein the browser is a web browser.

4. The computer program as claimed in claim 1, further including—
a code segment operable to acquire navigation information from the browser, and
a code segment operable to provide at least a portion of the navigation information acquired from the browser to the navigation device.

5. The computer program as claimed in claim 1, wherein the code segment is operable to access the navigation device through a local connection selected from the group consisting of a cable, a local network, a short-range wireless connection, and combinations thereof.

6. The computer program as claimed in claim 1, wherein the acquired navigation information is selected from the group consisting of a current geographic location of the navigation device, previous geographic locations of the navigation device, routes and trips calculated by the navigation device, points of interests, waypoints, fitness information, configuration information, and combinations thereof.

7. A method of utilizing navigation information, the method comprising:
locally accessing a navigation device to acquire navigation information;
interfacing with a browser; and
providing at least a portion of the acquired navigation information to the browser.

8. The method as claimed in claim 7, wherein the browser is a web browser.

9. The method as claimed in claim 7, wherein the navigation device is accessed through a local connection selected from the group consisting of a cable, a local network, a short-range wireless connection, and combinations thereof.

10. The method as claimed in claim 7, wherein the acquired navigation information is selected from the group consisting of a current geographic location of the navigation device, previous geographic locations of the navigation device, routes and trips calculated by the navigation device, points of interests, waypoints, fitness information, configuration information, and combinations thereof.

11. The method as claimed in claim 7, further including:
acquiring navigation information from the browser, and
providing at least a portion of the navigation information acquired from the browser to the navigation device.

12. A computer program stored on at least one computer-readable medium for operating a computing device, comprising:
a code segment operable to interface with a browser to acquire navigation information;
a code segment operable to locally access a navigation device; and
a code segment operable to provide at least a portion of the acquired navigation information to the navigation device.

13. The computer program as claimed in claim 12, wherein at least one of the code segments includes a plug-in for the browser.

14. The computer program as claimed in claim 12, wherein the browser is a web browser.

15. The computer program as claimed in claim 12, wherein the code segment is operable to access the navigation device through a local connection selected from the group consisting of a cable, a local network, a short-range wireless connection, and combinations thereof.

16. The computer program as claimed in claim 12, wherein the acquired navigation information is selected from the group consisting of a current geographic location of the navigation device, previous geographic locations of the navigation device, routes and trips calculated by the navigation device, points of interests, waypoints, fitness information, configuration information, and combinations thereof.

17. The computer program as claimed in claim 12, further including:
a code segment operable to identify an address displayed by the browser,
a code segment operable to generate a geocode using the identified address; and
a code segment operable to provide the generated geocode to the navigation device.

18. A method of utilizing navigation information, the method, comprising:
interfacing with a browser to acquire navigation information;
locally accessing a navigation device; and
providing at least a portion of the acquired navigation information to the navigation device.

19. The method as claimed in claim 18, wherein the browser is a web browser.

20. The method as claimed in claim 18, wherein the navigation device is accessed through a local connection selected from the group consisting of a cable, a local network, a short-range wireless connection, and combinations thereof.

21. The method as claimed in claim 18, wherein the acquired navigation information is selected from the group consisting of a current geographic location of the navigation device, previous geographic locations of the navigation device, routes and trips calculated by the navigation device, points of interests, waypoints, fitness information, configuration information, and combinations thereof.

22. The method as claimed in claim 18, further including:
identifying an address displayed by the browser,
generating a geocode using the identified address; and
providing the generated geocode to the navigation device.

23. A method of utilizing navigation information, the method comprising:
accessing a web server to retrieve a web page;
accessing a navigation device to acquire navigation information; and
presenting the web page utilizing the acquired navigation information.

24. The method as claimed in claim 23, where the web server is accessed through a communications network.

25. The method as claimed in claim 23, wherein the navigation device is accessed through a local connection selected from the group consisting of a cable, a local network, a short-range wireless connection, and combinations thereof.

26. The method as claimed in claim 23, further including communicating the acquired navigation information to a computing device selected from the group consisting of the web server and a computing device connected to a communications network.

27. The method as claimed in claim 23, wherein the acquired navigation information includes a geographic location and the presented web page includes a map indicating the position of the geographic location.

28. The method as claimed in claim 23, wherein the acquired navigation information includes fitness information and the presented web page includes a summary of the fitness information.

29. The method as claimed in claim 23, wherein the acquired navigation information includes navigation data.

30. The method as claimed in claim 23, wherein the acquired navigation information includes configuration information for the navigation device and the presented web page includes a comparison of the acquired configuration information with current configuration information.

31. A computer program stored on at least one computer-readable medium for operating a computing device, comprising:
a code segment operable to access a web server to retrieve a web page;
a code segment operable to access a navigation device to acquire navigation information; and
a code segment operable to present the web page utilizing the acquired navigation information.

32. The computer program as claimed in claim 31, further including a code segment operable to communicate the acquired navigation information to a computing device selected from the group consisting of the web server and a computing device connected to a communications network.

33. The computer program as claimed in claim 31, wherein the acquired navigation information includes a geographic location and the presented web page includes a map indicating the position of the geographic location.

34. The computer program as claimed in claim 31, wherein the acquired navigation information includes fitness information and the presented web page includes a summary of the fitness information.

35. The computer program as claimed in claim 31, wherein the acquired navigation information includes configuration information for the navigation device and the presented web page includes a comparison of the acquired configuration information with current configuration information.

36. The computer program as claimed in claim 31, wherein the code segment is operable to access the navigation device through a local connection selected from the group consisting of a cable, a local network, a short-range wireless connection, and combinations thereof.

37. A browser plug-in stored on at least one computer-readable medium for operating a computing device, comprising:
a code segment operable to interface with a web browser to acquire a first set of navigation information;
a code segment operable to locally access a navigation device to acquire a second set of navigation information, the code segment being operable to locally access the navigation device through a local connection selected from the group consisting of a cable, a local network, a short-range wireless connection, and combinations thereof;
a code segment operable to provide at least a portion of the first set of navigation information to the navigation device; and
a code segment operable to provide at least a portion of the second set of navigation information to the web browser.

38. The computer program as claimed in claim 37, wherein the first set of navigation information includes information selected from the group consisting of a current geographic location of the navigation device, previous geographic locations of the navigation device, routes and trips calculated by the navigation device, points of interests, waypoints, fitness information, configuration information, and combinations thereof.
